(19) United States
(12) Patent Application Publication
(10) Pub. No.: US 2026/0167124 A1
(43) Pub. Date: Jun. 18, 2026

(54) VEHICULAR INTERIOR COMPONENT

(71) Applicant: TOYOTA BOSHOKU KABUSHIKI KAISHA, Aichi-ken (JP)

(72) Inventors: Yuki MIZUNO, Aichi-gun (JP); Yuichi KOBAYASHI, Ikeda-shi (JP)

(73) Assignee: TOYOTA BOSHOKU KABUSHIKI KAISHA, Aichi-ken (JP)

(21) Appl. No.: 19/411,704

(22) Filed: Dec. 8, 2025

(30) Foreign Application Priority Data
Dec. 12, 2024 (JP) 2024-217441

(51) Int. Cl. B60R 13/02

(52) U.S. Cl. CPC B60R 13/0243

(57) ABSTRACT

A vehicular interior component includes an interior component body that has a vehicular interior side surface as a design surface and includes a projection portion projecting toward a vehicular interior side, and a decoration member that covers a vehicular interior side surface of the projection portion. The decoration member includes a decoration body having a plate shape and a vehicular interior side surface as a projection portion design surface, and a first stopper piece that extends downward from a vehicular exterior side surface of the decoration body and is contacted with a portion of the interior component body from a vehicular exterior side.

### CROSS REFERENCE TO RELATED APPLICATION

This application claims priority from Japanese Patent Application No. 2024-217441 filed on Dec. 12, 2024. The entire contents of the priority application are incorporated herein by reference.

### TECHNICAL FIELD

The present technology described herein relates to a vehicular interior component.

### BACKGROUND

There has been known a door trim of a side door of a vehicle as a vehicular interior component. One example of a door trim includes a door trim body (an interior component body) that is configured as a main body having a vehicular interior side design surface and the door trim body includes a projection portion that projects toward the vehicular interior side. An upper surface member including a switch base and a pull handle is fitted in an upper section of the projection portion. A garnish (a decoration member) extending in a front-rear direction is disposed in a border portion between the upper surface member and the projection portion. In such a door trim, a gap may be created between the projection portion of the trim body and the garnish and the garnish may be detached easily from the projection portion of the trim body. To cope with such problems, in the door trim, a first fitting portion of the upper surface member is fitted to a first receiving portion of the projection portion with the first fitting portion being inserted in a through hole of the garnish.

### SUMMARY

In such a vehicular interior component, the garnish, which is a decoration member, has a linear shape; however, an entire area of the vehicular interior side surface of the projection portion or any other portions may be necessary to be decorated. In such a case, the fitting structure of decoration members may be different from the fitting structure described above to cope with the problems described above.

An object of the present technology described herein is to provide a vehicular interior component in which a gap is less likely to be created between a projection portion of an interior component body and a decoration member and the decoration member is less likely to be detached from the projection portion of the interior component body in case of a collision.

According to the technology described herein, a vehicular interior component in which a gap is less likely to be created between a projection portion of an interior component body and a decoration member and the decoration member is less likely to be detached from the projection portion of the interior component body in case of a collision is provided.

### BRIEF DESCRIPTION OF THE DRAWINGS

FIG. 1 is a perspective view of a door trim of a vehicle according to one embodiment.

FIG. 2 is a perspective view illustrating a projection portion of the trim board.

FIG. 3 is a perspective view illustrating the projection portion to which a cover member is attached.

FIG. 4 is a perspective view of the cover member seen from a vehicular interior side and an upper side.

FIG. 5 is a perspective view of the cover member seen from a vehicular exterior side and a lower side.

FIG. 6 is a cross-sectional view illustrating the cover member and a trim board that are attached together.

FIG. 7 is a cross-sectional view illustrating the cover member and the trim board that are attached together

FIG. 8 is a perspective view of an ornament board seen from the vehicular exterior side.

FIG. 9 is a cross-sectional view illustrating a portion of the ornament board that is attached to the projection portion.

FIG. 10 is a cross-sectional view illustrating another portion of the ornament board that is attached to the projection portion.

FIG. 11 is a cross-sectional view illustrating other portion of the ornament board that is attached to the projection portion.

FIG. 12 is a perspective view of a vehicular front section of the projection portion seen from the vehicular exterior side.

FIG. 13 is a cross-sectional view of the portion of the ornament board that is being attached to the projection portion corresponding to the portion in FIG. 9.

FIG. 14 is a cross-sectional view of the portion of the ornament board that is being attached to the projection portion corresponding to the portion in FIG. 10.

FIG. 15 is a cross-sectional view of the portion of the ornament board that is being attached to the projection portion corresponding to the portion in FIG. 11.

### DETAILED DESCRIPTION

A vehicular door trim 10 according to one embodiment of a vehicular interior component will be described. The door trim 10 of this embodiment is configured as a portion of a vehicular side door and is disposed to cover a door panel of the side door from a vehicular interior side. An armrest 12, a pull handle 13, a switch base 14, a door pocket 15, and an inside handle 16 are included in the door trim 10. In the drawings, arrows of Fr and Rr represent a front side and a rear side of a vehicle, arrows of IN and OUT represent a vehicular interior side and a vehicular exterior side with respect to a vehicular width direction, and arrows U and D represent an upper side and a lower side.

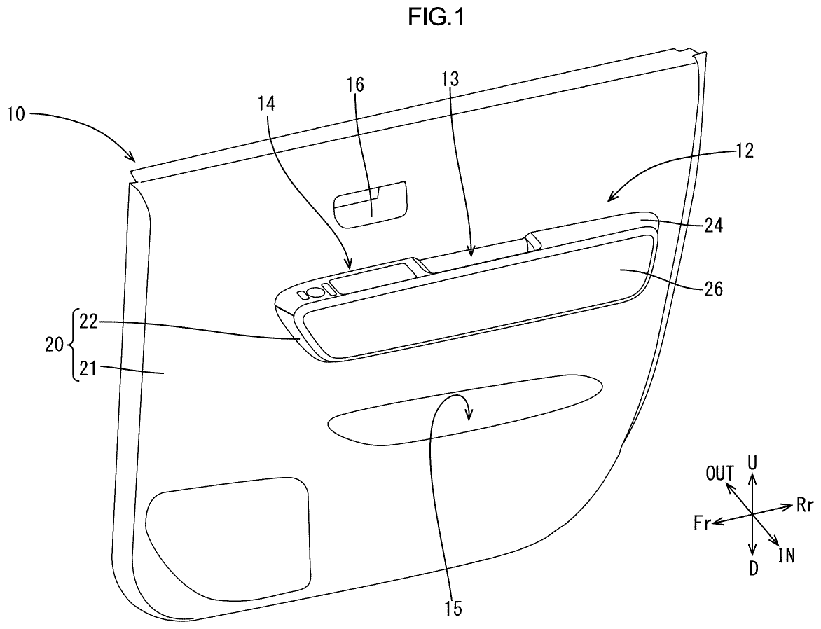

As illustrated in FIG. 1, the door trim 10 includes a trim board 20 (an interior component body) having a plate shape. The trim board 20 corresponds to an interior component body having a surface as a vehicular interior design surface (a vehicular interior side surface, a design surface). The trim board 20 is made of synthetic resin such as polypropylene and mixture of synthetic resin and wood base material (such as kenaf, hemp, flax, sisal).

As illustrated in FIG. 1, the trim board 20 includes a design surface portion 21 (a body portion) having the design surface and a projection portion 22 that projects from the design surface portion 21 toward the vehicular interior side. The projection portion 22 is in a middle portion of the trim board 20 with respect to an upper-bottom direction and has an elongated shape extending in a vehicular front-rear direction (a horizontal direction). The projection portion 22 has an elongated rectangular shape. A cover member 24 (an upper surface member) is on an upper surface side of the projection portion 22 and an ornament board 26 (a decoration member) having a plate shape is on a vehicular interior side of the projection portion 22. The ornament board 26 faces an interior space of a vehicle. A rear section of the cover member 24 is configured as the armrest 12 and the pull handle 13 is on a vehicular front side of the armrest 12. The switch base 14 is disposed on the vehicular front side of the pull handle 13.

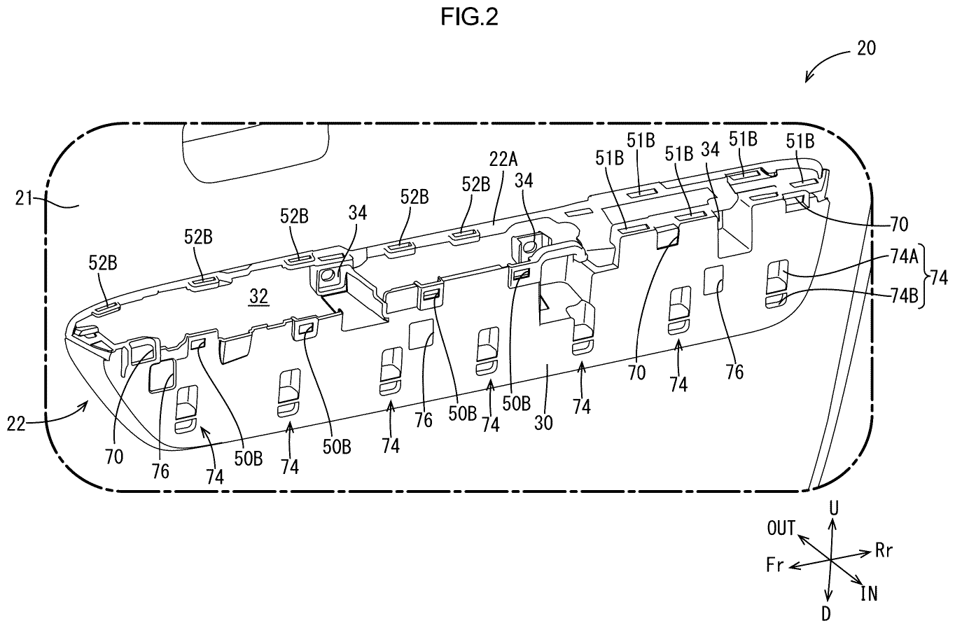

As illustrated in FIG. 2, the projection portion 22 has a rectangular box shape. The projection portion 22 includes a wall surface section 30 on a projecting end surface and an upper surface section 22A. The wall surface section 30 extends in the upper-bottom direction and vehicular front-rear direction and faces the vehicular interior side. The wall surface section 30 is more to the vehicular interior side than the design surface portion 21. The upper surface section 22A extends in the front-rear direction and the vehicular width direction and faces upward. The projection portion 22 includes a hole 32 in the upper surface section 22A and the projection portion 22 opens upward through the hole 32. The cover member 24 is disposed to cover the hole 32. The ornament board 26 is mounted to cover the wall surface section 30 of the projection portion 22. In this embodiment, after the cover member 24 is attached to the projection portion 22, the ornament board 26 is attached to the cover member 24 and the projection portion 22. The ornament board 26 has a vehicular interior side surface as a design surface.

As previously described, the projection portion 22 includes the pull handle 13. Therefore, the projection portion 22 is fixed to a door panel to receive a force applied in the vehicular interior-exterior direction. Specifically, as illustrated in FIG. 2, fixing portions 34 project from the wall surface section 30 toward the vehicular exterior side. The fixing portions 34 (three fixing portions 34 in this embodiment) are arranged in the vehicular front-rear direction. The projection portion 22 is fixed to a door inner panel at the fixing portions 34 with fixing members such as screws.

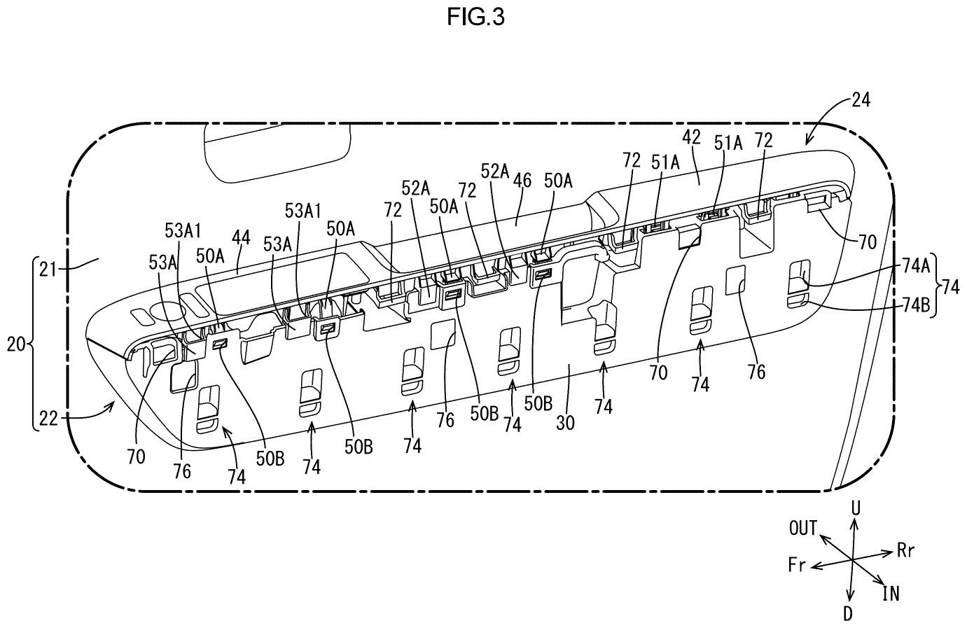

The cover member 24 is made of material having rigidity higher than that of the trim board 20. With the trim board 20 being made of polypropylene, the cover member 24 is made of ABS resin, for instance. As illustrated in FIG. 3, the cover member 24 is attached to the projection portion 22 from above.

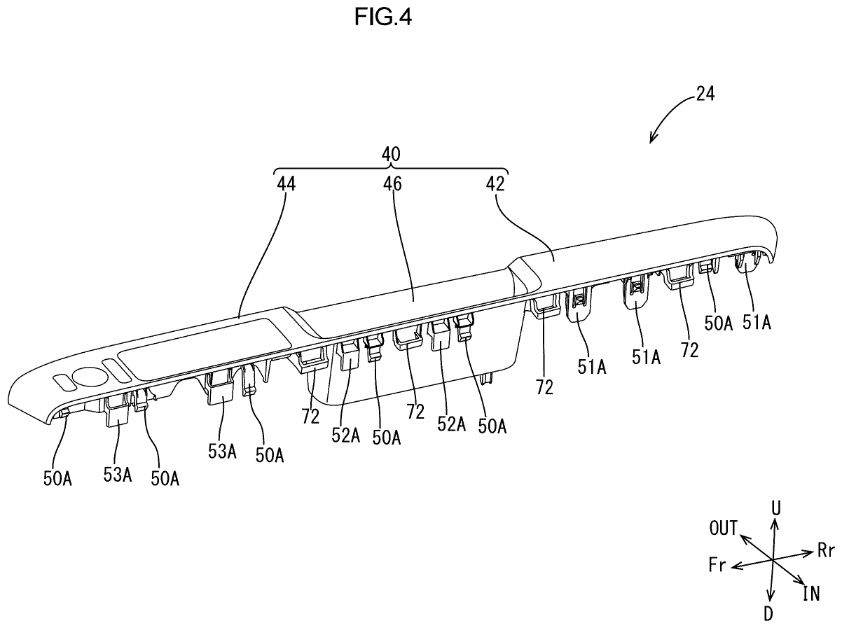

As illustrated in FIG. 4, the cover member 24 includes a cover body 40 that is configured as an upper surface of the projection portion 22. The cover body 40 includes a rear section as an armrest 42 having a flat shape, a front section as a switch bezel 44 for the switch base 14, and a middle section as a pull handle box 46 (the pull handle) that opens upward. The cover member 24 is fixed to the projection portion 22 of the trim board 20 at a peripheral edge portion of the cover body 40 with the pull handle box 46 of the cover member 24 being inserted in the hole 32 of the pull handle box 46.

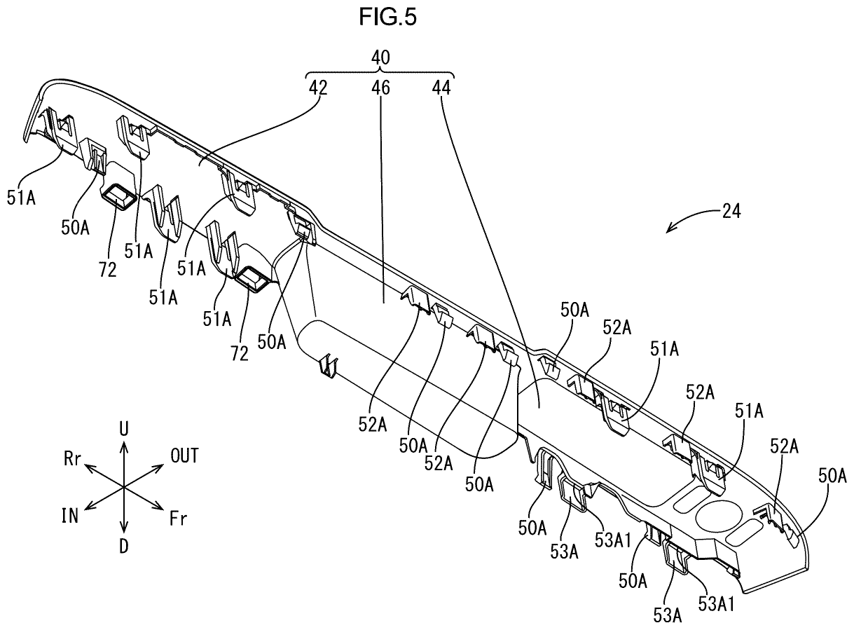

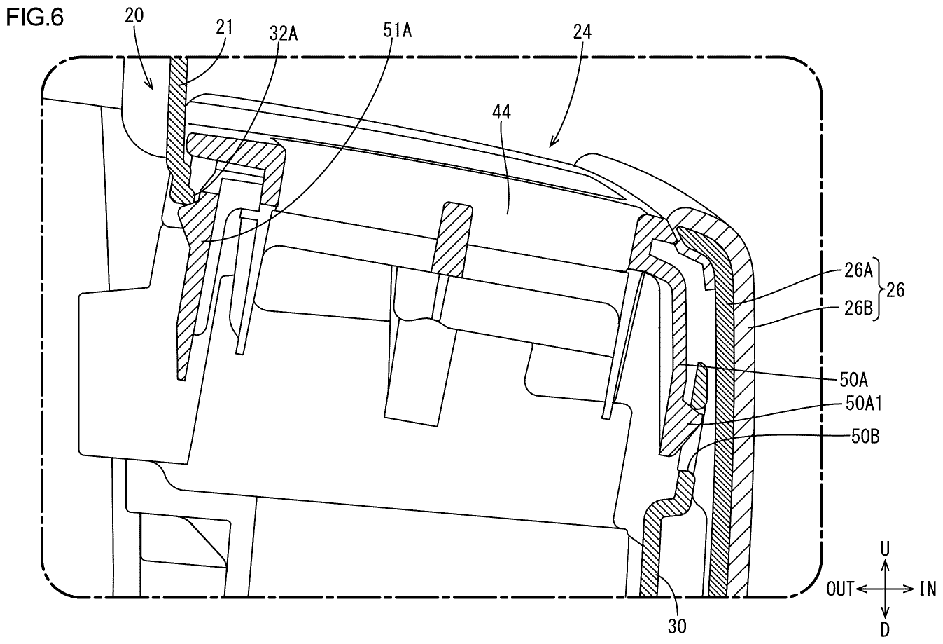

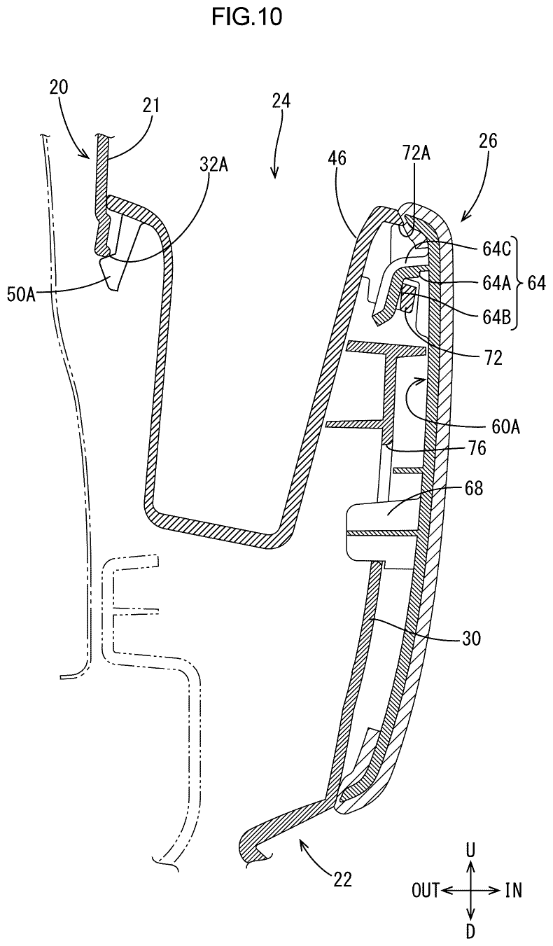

As illustrated in FIGS. 4 and 5, fitting projections 50A, 51A and stopper pieces 52A, 53A are on a lower surface of the peripheral edge portion of the cover body 40. The fitting projections 50A, 51A and the stopper pieces 52A, 53A are on the vehicular interior side portion and the vehicular exterior side portion of the peripheral edge portion of the cover body 40. The fitting projection 50A projects downward from the cover body 40 and includes a mountain-shaped projection 50A1 at a distal end. The fitting projection 50A is configured to be warped at a basal portion. The fitting projection 51A projects downward from the cover body 40 and is a flat-shaped projection. The fitting projection 51A includes a U-shaped through hole in a middle portion. With such a configuration, the fitting projection 51A is configured such that only the middle portion is warped. As illustrated in FIGS. 3 and 6, the fitting projection 50A that is on the vehicular interior side portion of the peripheral edge portion is inserted in a through hole 50B of the wall surface section 30 of the projection portion 22 and the projection 50A1 at the distal end of the fitting projection 50A is contacted with a hole edge of the through hole 50B from a lower side. Thus, the fitting projection 50A is fitted in and fixed to the through hole 50B. The fitting projection 50A is stopped by the hole edge of the through hole 50B. As illustrated in FIG. 10, the fitting projection 50A that is on the vehicular exterior side portion of the peripheral edge portion is contacted with a hole edge 32A of the hole 32 from a lower side and fixed. The fitting projection 50A on the vehicular exterior side portion of the projection portion 22 is stopped by the hole edge 32A. Some of the fitting projections 51A are inserted in long holes 51B that are through the upper surface section 22A of the projection portion 22. The long holes 51B are in a rear section of the projection portion 22. The fitting projections 51A that are inserted in the long holes 51B are contacted with the hole edge portions of the long holes 51B from a lower side and fixed. Some of the fitting projections 51A are contacted with the hole edge 32A of the hole 32 from a lower side and fixed as illustrated in FIG. 6. Some of the fitting projections 51A are stopped by the hole edge portion of the long hole 51B and some of the fitting projections 51A are stopped by the hole edge 32A of the hole 32.

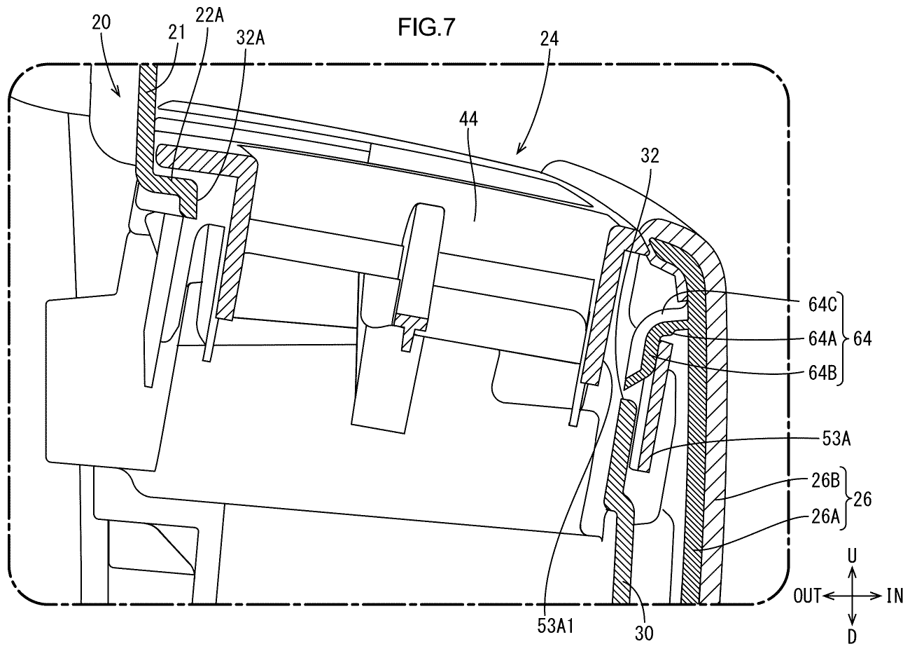

As illustrated in FIG. 3, some of the stopper pieces 52A that are disposed on the vehicular interior side portion of the peripheral edge portion of the cover body 40 are hooked on the upper edge portion of the wall surface section 30 of the projection portion 22 and disposed on the vehicular interior side of the wall surface section 30. Some of the stopper pieces 52A that are disposed on the vehicular exterior side portion of the peripheral edge portion of the cover body 40 are inserted in long holes 52B that are through the upper surface section 22A of the projection portion 22. The long holes 52B are in a front section and a middle section of the projection portion 22. The stopper pieces 52A that are on the vehicular exterior side portion of the peripheral edge portion of the cover body 40 are contacted with and stopped by hole edge portions of the long holes 52B from a lower side. As illustrated in FIG. 7, the stopper pieces 53A are hooked on the upper edge portion of the wall surface section 30 of the projection portion 22 and are on the vehicular interior side of the wall surface section 30 similar to the stopper pieces 52A that are disposed on the vehicular interior side portion. The stopper pieces 53A have a tubular shape and open upward unlike the stopper pieces 52A. Portions of the ornament board 26 are fitted to and hooked on the stopper pieces 53A.

Accordingly, the cover member 24 is less likely to move upward and detached from the projection portion 22 with the fitting projections 50A, 51A and the movement of the cover member 24 in the front-rear direction and the vehicular interior-exterior direction is restricted with the fitting projections 51A and the stopper pieces 52A, 53A.

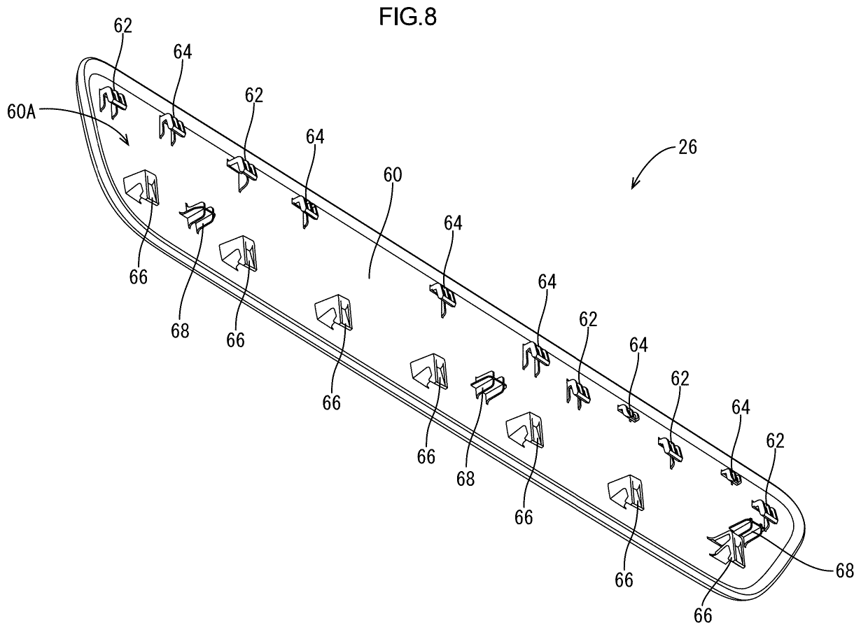

As illustrated in FIGS. 6 and 7, the ornament board 26 includes a base member 26A and a skin 26B that covers a surface of the base member 26A. The ornament board 26 is for decorating the wall surface section 30 of the projection portion 22. As illustrated in FIG. 8, the base member 26A of the ornament board 26 includes a decoration body 60, first stopper pieces 62, second stopper pieces 64, fitting projections 66, and positioning projections 68. The decoration body 60 is a plate member having a vehicular interior side surface as a projection portion design surface, which is a design surface of the projection portion 22. The first stopper pieces 62, the second stopper pieces 64, the fitting projections 66, and the positioning projections 68 are on a vehicular exterior side surface 60A of the decoration body 60.

As illustrated in FIG. 8, the first stopper pieces 62 and the second stopper pieces 64 are arranged along an upper edge of the decoration body 60 and the fitting projections 66 are arranged along a lower edge of the decoration body 60. The first stopper pieces 62 and the second stopper pieces 64 are arranged upper than the fitting projections 66. The first stopper pieces 62, the second stopper pieces 64, and the fitting projections 66 have an L-shape and project from the vehicular exterior side surface 60A of the decoration body 60 and are bent and extend downward.

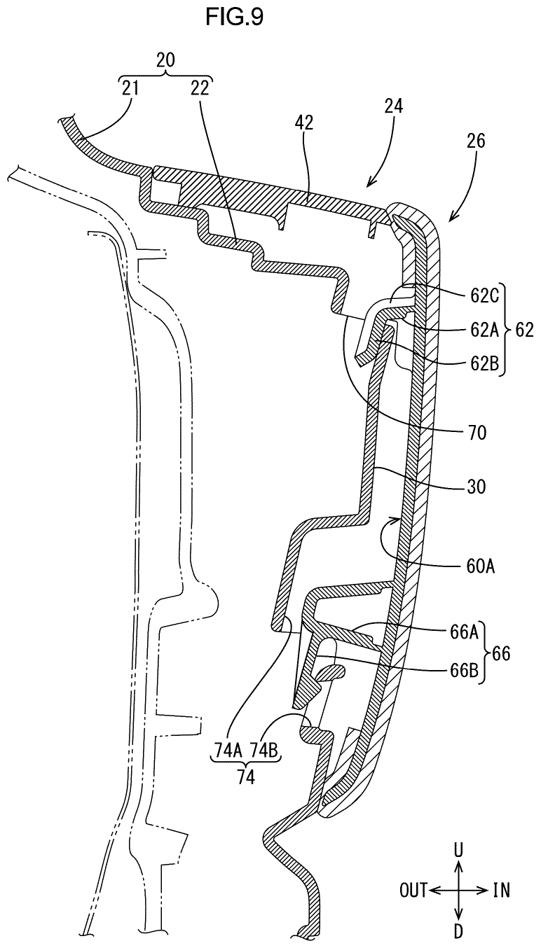

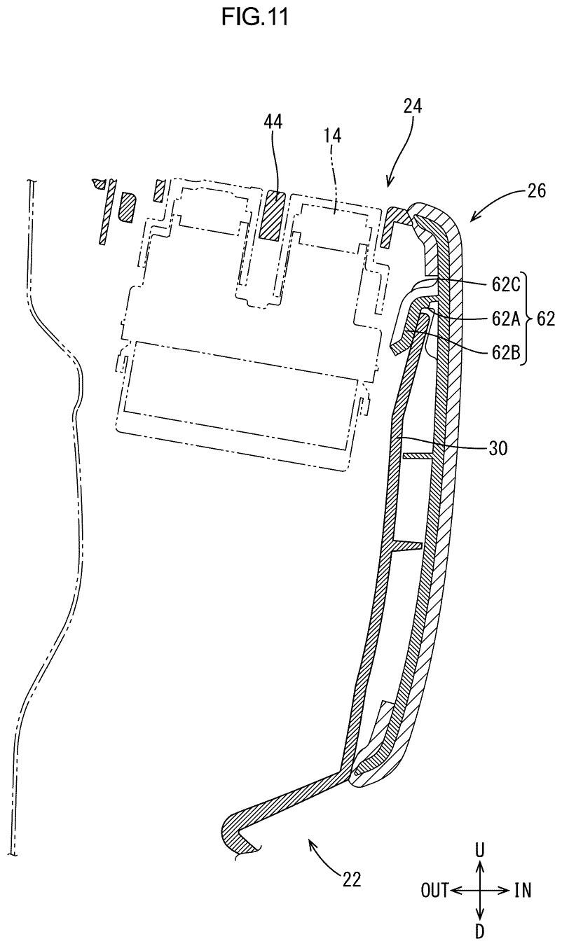

More in detail, as illustrated in FIGS. 9 and 11, the first stopper piece 62 includes a lateral extending portion 62A, a downward extending portion 62B, and a rib 62C. The lateral extending portion 62A extends from the vehicular exterior side surface 60A of the decoration body 60 toward the vehicular exterior side. The downward extending portion 62B extends downward from the vehicular exterior side end of the lateral extending portion 62A. The rib 62C is on the vehicular exterior side surfaces of the lateral extending portion 62A and the downward extending portion 62B. The rib 62C extends along an extending direction in which the lateral extending portion 62A and the downward extending portion 62B extend. The first stopper pieces 62 have rigidity higher than the fitting projections 66 and are less likely to be elastically deformed. As illustrated in FIG. 11, some of the first stopper pieces 62 are hooked on an upper edge portion of the wall surface section 30 of the projection portion 22 and the downward extending portions 62B are contacted with the upper edge portion of the wall surface section 30 from the vehicular exterior side. The downward extending portions 62B are disposed on the vehicular exterior side of the wall surface section 30.

As illustrated in FIGS. 2, 3, and 9, the projection portion 22 includes a through hole 70 in a vehicular interior edge portion of the upper surface section 22A so as to be through in the upper-bottom direction. The through hole 70 is at a corner between the wall surface section 30 and the upper surface section 22A. As illustrated in FIGS. 2 and 3, two through holes 70 are in a front and rear end portion of the projection portion 22, respectively, and one through hole 70 is between the two through holes 70. Two through holes 70 that are in the rear section of the projection portion 22 that corresponds to the armrest 42. As illustrated in FIG. 9, some of the first stopper pieces 62 corresponding to the through holes 70 are fitted in the through holes 70 and hooked on and stopped by the hole edges of the through holes 70. The downward extending portion 62B is disposed on the vehicular exterior side of the wall surface section 30. The downward extending portion 62B is stopped by the upper edge portion of the wall surface section 30. The first stopper pieces 62 are fitted to and connected to the projection portion 22.

The second stopper pieces 64 have a similar shape as that of the first stopper pieces 62. As illustrated in FIGS. 7 and 10, the second stopper piece 64 includes a lateral extending portion 64A, a downward extending portion 64B, and a rib 64C. The second stopper pieces 64 are fitted to and connected to the cover member 24. As illustrated in FIG. 7, two of the second stopper pieces 64 that are on a front section of the decoration body 60 are fitted to the tubular-shaped stopper pieces 53A of the cover member 24. More in detail, as illustrated in FIG. 7, the stopper piece 53A of the cover member 24 includes a through hole 53A1 that is through in the upper-bottom direction. The downward extending portion 64B of the second stopper piece 64 is inserted in the through hole 53A1 from above and is stopped by the upper edge portion of the stopper piece 53A. Thus, the two second stopper pieces 64 are contacted with the inner surfaces of the stopper pieces 53A of the cover member 24 from the vehicular exterior side. Specifically, the downward extending portions 64B of the two second stopper pieces 64 are contacted with the inner surfaces of the stopper pieces 53A that face the vehicular exterior side.

As illustrated in FIGS. 3 and 4, the cover member 24 includes fitting stoppers 72 in a middle section of the cover body 40 corresponding to the pull handle box 46. The second stopper pieces 64 corresponding to the fitting stoppers 72 are fitted to and stopped by the fitting stoppers 72. As illustrated in FIG. 3, the fitting stoppers 72 have a tubular shape that is through in the upper-bottom direction. As illustrated in FIG. 10, the fitting stoppers 72 project from the cover body 40 toward the vehicular interior side and the downward extending portions 64B of the second stopper pieces 64 are fitted in a fitting hole 72A of the fitting stoppers 72 from an upper side. The second stopper pieces 64 are hooked on the fitting stoppers 72. The second stopper pieces 64 are contacted with the fitting stoppers 72 of the cover member 24 from the vehicular exterior side. The downward extending portions 64B of the second stopper pieces 64 are on the vehicular exterior side of the fitting stoppers 72. The second stopper piece 64 that is through the fitting hole 72A is contacted with a hole edge of the fitting hole 72A from the vehicular exterior side. The second stopper pieces 64 are connected to the cover member 24.

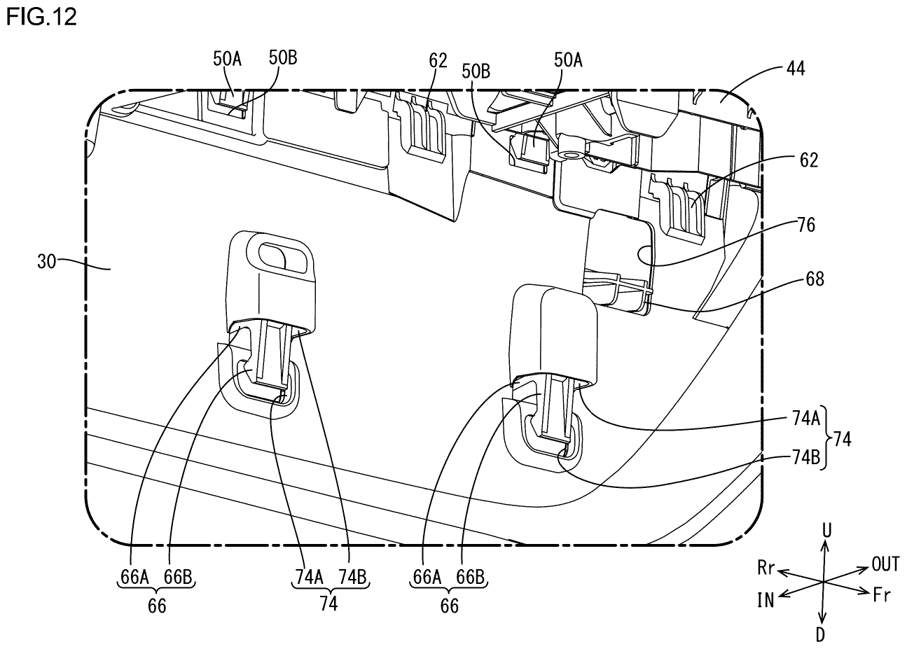

As illustrated in FIG. 9, the fitting projection 66 includes a base portion 66A and projection portion 66B. The base portion 66A has a box shape projecting from the decoration body 60 toward the vehicular exterior side. The projection portion 66B extends downward from a vehicular exterior end portion of the base portion 66A and includes a stopper projection 66C at an extending end of the projection portion 66B. The stopper projection 66C projects from the lower end of the projection portion 66B toward the decoration body 60 (the vehicular interior side). As illustrated in FIGS. 2 and 3, the wall surface section 30 of the projection portion 22 includes fitting portions 74 in a lower edge portion. The fitting projections 66 are fitted to the fitting portions 74, respectively. As illustrated in FIGS. 2, 3, 9, and 12, the fitting portion 74 includes a recessed portion 74A and a through hole 74B. The recessed portion 74A is recessed toward the vehicular exterior side and opens downward. The through hole 74B is below the recessed portion 74A and through the wall surface section 30 in the vehicular interior-exterior direction. When the fitting projection 66 is inserted in the recessed portion 74A and through the opening of the recessed portion 74A, the stopper projection 66C of the projection portion 66B is contacted with the hole edge of the through hole 74B and the projection portion 66B is moved downward with being warped (deformed) toward the vehicular exterior side. Then, the stopper projection 66C of the projection portion 66B is inserted in the through hole 74B from the vehicular exterior side as illustrated in FIG. 9 and the fitting projection 66 is fitted to the fitting portion 74.

The positioning projections 68 are inserted in through holes 76 that are square holes and formed in the wall surface section 30 of the projection portion 22 as illustrated in FIGS. 2, 3, and 10. With such a configuration, the position of the ornament board 26 with respect to the projection portion 22 in the vehicular front-rear direction is determined when the ornament board 26 is attached to the projection portion 22 and the cover member 24.

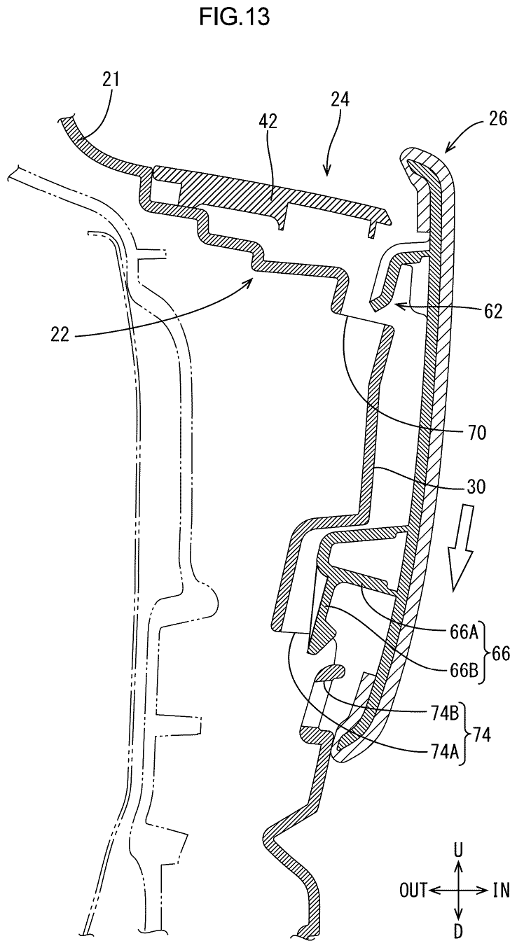

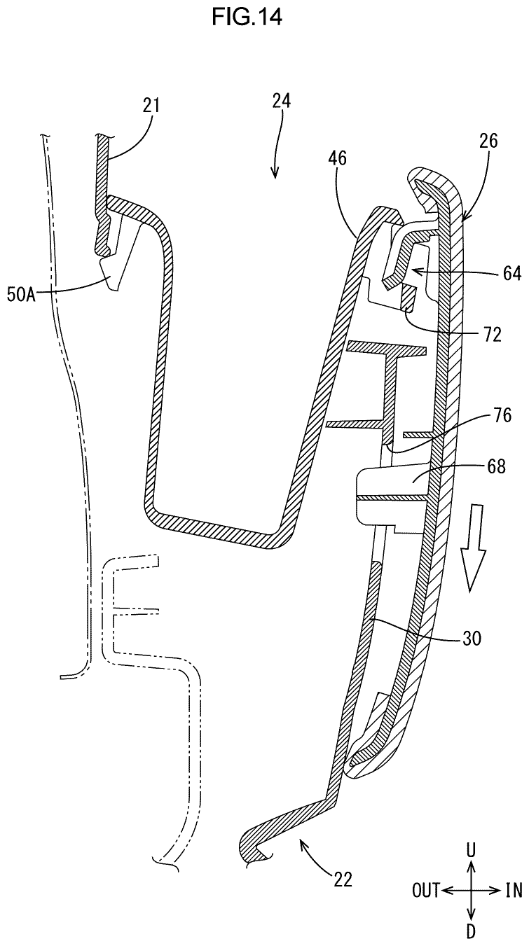

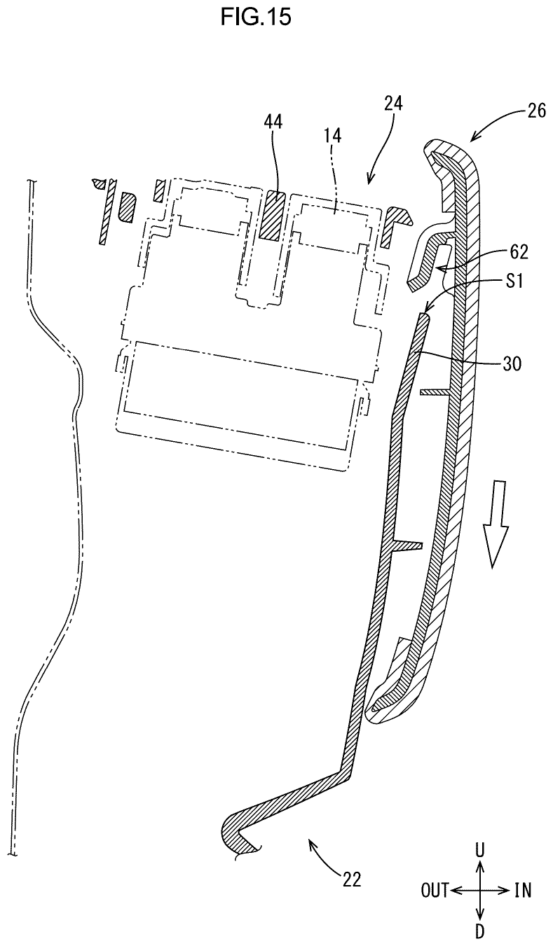

Next, a method of attaching the ornament board 26 will be described with reference to FIGS. 13 to 15. The ornament board 26 is moved closer to the projection portion 22 from the vehicular interior side to insert the positioning projections 68 in upper sections of the through holes 76, respectively, and insert the fitting projections 66 into the recessed portions 74A of the fitting portions 74, respectively, as illustrated in FIGS. 13 and 14. At this time, the first stopper pieces 62 are put in the through holes 70 and a space S1 between the projection portion 22 and the cover member 24 as illustrated in FIGS. 13 and 15 and the second stopper pieces 64 are disposed above the stopper pieces 53 and the fitting stoppers 72 with reference to FIG. 7 and as illustrated in FIG. 14. Then, with the ornament board 26 being moved downward, the fitting projections 66 are fitted to the fitting portions 74 and the first stopper pieces 62 are hooked on portions of the projection portion 22 and the second stopper pieces 64 are hooked on portions of the cover member 24.

With the above configuration, in the door trim 10, the first stopper piece 62 is configured to be fitted to the trim board 20 without requiring large elastic deformation and only hooked on a portion of the trim board 20. A gap is less likely to be created between the projection portion 22 and the ornament board 26. The ornament board 26 is connected to the cover member 24 including the pull handle box 46 with the second stopper pieces 64 being hooked on the cover member 24. Accordingly, the ornament board 26 is connected to the cover member 24 so as to restrict movement in the vehicular interior-exterior direction (the vehicular width direction). Therefore, even with a force directed in the vehicular interior-exterior direction being applied to the ornament board 26 from the pull handle 13, a gap is less likely to be created between the cover member 24 and the ornament board 26. As illustrated in FIGS. 3 and 8, the ornament board 26 is connected to the cover member 24 with the second stopper pieces 64 being hooked on the fitting stoppers 72 that are included in a front section, a middle section, and a rear section of the pull handle box 46. Accordingly, the ornament board 26 is connected to the cover member 24 so as to restrict movement in the vehicular interior-exterior direction (the vehicular width direction). Therefore, a gap is further less likely to be created between the cover member 24 and the ornament board 26. As illustrated in FIGS. 3 and 8, the first stopper pieces 62 and the second stopper pieces 64 are alternately arranged in the portions of the ornament board 26 corresponding to the switch base 14, which is on the front side of the pull handle 13, and the armrest 12, which is on the rear side of the pull handle 13. Therefore, if the ornament board 26 receives a force directed in the vehicular interior-exterior direction from the pull handle 13, the cover member 24 and the ornament board 26 are less likely to be separated from the projection portion 22.

With the ornament board 26 being on the vehicular interior side of the projection portion 22 and the cover member 24, the first stopper pieces 62 and the second stopper pieces 64 of the ornament board 26 are contacted with and stopped by the projection portion 22 or the cover member 24 from the vehicular exterior side. Therefore, even if a side collision occurs on the vehicle including the door trim 10 of this embodiment, the ornament board 26 is less likely to be detached or separated from the projection portion 22. In such a side collision, an air bag may inflate from a seat that is on the vehicular interior side of the door trim 10. Even in such a case, the ornament board 26 is less likely to be separated from the projection portion 22 and therefore, the inflation of the airbag is less likely to be obstructed by the separated ornament board 26.

Furthermore, in the door trim 10 of this embodiment, the structure of attaching the ornament board 26 to the projection portion 22 does not require a large space with respect to the vehicular interior-exterior direction. Therefore, the structure is preferably applied to a vehicle that has a restricted dimension in the vehicular width direction such as kei cars, which are small cars.

### Other Embodiments

The technology described herein is not limited to the embodiments described above with reference to the drawings. The following embodiments may be included in the technical scope. The technology described herein may be modified within the technical scope.

In the above embodiment, all the fitting projections 66 extend downward; however, the fitting projections may extend toward the vehicular exterior side if the projection portion ha a sufficient space extending in the vehicular interior-exterior direction.

In the above embodiment, the first stopper pieces 62 are on the upper side of the fitting projections 66; however, the first stopper pieces 62 may be on the lower portion of the decoration body and the fitting projections 66 may be on the upper portion.

In the above embodiment, the vehicular door trim is described as one example of the vehicular interior component. However, the present technology may be used for decorating a projection portion of a vehicular interior component other than the door trim (such as an instrument panel, a pillar garnish, and a roof lining).

The vehicular interior component of the above embodiment may not be necessarily included in an automobile but may be included in various kinds of vehicles. Examples of the vehicles may be vehicles running on the ground such as a train and an amusement vehicle, flying vehicles such as an airplane and a helicopter, and vehicles on the sea such as a ship.

1. A vehicular interior component comprising:
an interior component body that has a vehicular interior side surface as a design surface and includes a projection portion projecting toward a vehicular interior side; and
a decoration member that covers a vehicular interior side surface of the projection portion, the decoration member including
a decoration body having a plate shape and a vehicular interior side surface as a projection portion design surface, and
a first stopper piece that extends downward from a vehicular exterior side surface of the decoration body and is contacted with a portion of the interior component body from a vehicular exterior side.

2. The vehicular interior component according to claim 1, wherein
the projection portion has an elongated shape extending in a horizontal direction,
the decoration member is an elongated member extending in the horizontal direction,
the first stopper piece includes first stopper pieces,
the decoration member includes fitting projections that extend downward from the vehicular exterior side surface of the decoration body and include stopper projections at distal ends of the fitting projections, the stopper projections projecting in a vehicular interior-exterior direction, the fitting projections being fitted to the interior component body from a lower side.

3. The vehicular interior component according to claim 2, wherein
the fitting projections are arranged in the horizontal direction, and
the first stopper pieces are arranged in the horizontal direction on an upper side of the fitting projections.

4. The vehicular interior component according to claim 1, wherein
the vehicular interior component is a door trim of a side door,
the projection portion includes a pull handle portion on an upper surface section of the projection portion, and
the first stopper pieces are fitted to the interior component body on the vehicular interior side of the pull handle portion.

5. The vehicular interior component according to claim 1, further comprising an upper surface member that covers a hole of the projection portion, the projection portion opening upward through the hole, wherein
the decoration member includes a second stopper piece that is contacted with the upper surface member from a vehicular exterior side.

6. The vehicular interior component according to claim 5, wherein
the vehicular interior component is a door trim of a side trim,
the upper surface member includes a pull handle portion, and
the second stopper piece is fitted to the upper surface member and is on the vehicular interior side of the pull handle portion.

7. The vehicular interior component according to claim 6, wherein
the first stopper piece includes first stopper pieces,
the second stopper piece includes second stopper pieces, and
the first stopper pieces and the second stopper pieces are arranged alternately and horizontally in a portion of the decoration member on a front side of the pull handle portion and a portion of the decoration member on a rear side of the pull handle portion.

8. The vehicular interior component according to claim 1, wherein the projection portion includes a through hole in which the first stopper piece is fitted.

9. The vehicular interior component according to claim 8, wherein
the projection portion includes a wall surface section that faces the vehicular interior side and an upper surface section that faces upward,
the upper surface section includes the through hole,
the first stopper piece that is fitted through the through hole is contacted with a hole edge of the through hole from the vehicular exterior side.

10. The vehicular interior component according to claim 9, further comprising an upper surface member that covers a hole of the upper surface section, wherein
the decoration member includes a second stopper piece that extends downward from the vehicular exterior side surface of the decoration body and is contacted with the upper surface member from a vehicular exterior side.

11. The vehicular interior component according to claim 10, wherein
the upper surface member includes a fitting stopper that has a fitting hole through which the second stopper piece is fitted, and
the second stopper piece that is through the fitting hole is contacted with a hole edge of the fitting hole from the vehicular exterior side.

12. The vehicular interior component according to claim 2, further comprising an upper surface member that covers a hole of the projection portion, the projection portion opening upward through the hole, wherein
the decoration member includes second stopper pieces that are contacted with the upper surface member from a vehicular exterior side.

13. The vehicular interior component according to claim 5, wherein the second stopper piece extends downward from the vehicular exterior side surface of the decoration body.

14. The vehicular interior component according to claim 13, wherein
the upper surface member includes a cover body having a plate shape and fitting projections that project downward from the cover body, and
the fitting projections are fitted to the interior component body from a lower side.
